(19) United States
(12) Patent Application Publication
(10) Pub. No.: US 2006/0110583 A1
(43) Pub. Date: May 25, 2006

(54) Conformable design templates for pumpkin carving

(76) Inventors: Trevor Jackson, Kirtland, OH (US); Patrick Coyne, Shaker Heights, OH (US); Harry Klaus, Adams Ridge, PA (US); Marsha Dunmyre, Butler, PA (US)

Correspondence Address: CALFEE HALTER & GRISWOLD, LLP, 800 SUPERIOR AVENUE, SUITE 1400, CLEVELAND, OH, 44114, US

(21) Appl. No.: 11/201,780

(22) Filed: Aug. 11, 2005

Related U.S. Application Data
(60) Provisional application No. 60/600,542, filed on Aug. 11, 2004.

(51) Int. Cl. G03G 7/00

(52) U.S. Cl. 428/195.1

(57) ABSTRACT

Conformable design templates and methods for making and using the same are provided for rendering a design on or through all or a portion of a substrate, such as, for example, a pumpkin, other large fruit or vegetable, artificial replicas of the same, and other compliant substrates. The conformable design templates are particularly useful for facilitating the etching or carving of pumpkins and similar vegetables and replicas thereof for display as decor, and more particularly as holiday decor items. The conformable design templates include conformable sheets that are reversibly adherent when contacted with a substrate, such as when contacted with the surface of a substrate.

### PRIORITY CLAIM

This application claims priority to U.S. Provisional Patent Application 60/600,542, filed Aug. 11, 2004, which is incorporated herein by reference, in its entirety.

### TECHNICAL FIELD

The present invention relates generally to conformable design templates and methods for making and using the same for rendering a design on or through all or a portion of a substrate, such as, for example, a pumpkin, other large fruit or vegetable, artificial replicas of the same, and other compliant substrates. The conformable design templates are particularly useful for facilitating the etching or carving of pumpkins and similar vegetables and replicas thereof for display as decor, and more particularly as holiday decor items.

### SUMMARY OF THE INVENTION

The conformable design templates include a flexible conformable sheet adapted to conform to a substrate surface when applied thereto. The conformable sheets may be made of one or more layers, and have first and second sides, at least one of which sides is a bonding side that has an adhesive surface. In some embodiments, the conformable design templates are reversibly adherent when contacted with a the surface of a substrate. In some embodiments, the conformable design templates comprise a film. The conformable sheets are adapted to receive design pattern elements applied by the user, or they comprise pattern design elements pre-formed on or through the conformable sheets. The pattern design elements may be on the bonding side of the sheet, or on the opposing side, or both, and are used as a guide in rendering a design on or through a substrate.

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention, and together with the description, serve to explain the principles of the invention.

### BRIEF DESCRIPTION OF THE DRAWINGS

FIG. 1 is a profile view of a conformable design template;

FIG. 2 is a front view of a substrate to which a conformable design template has been adhered;

FIG. 3 is a view of a conformable sheet aligned with a two backing sheets, each backing sheet aligned so as to be contacted respectively to the bonding side of the conformable sheet and the pattern side of the conformable sheet;

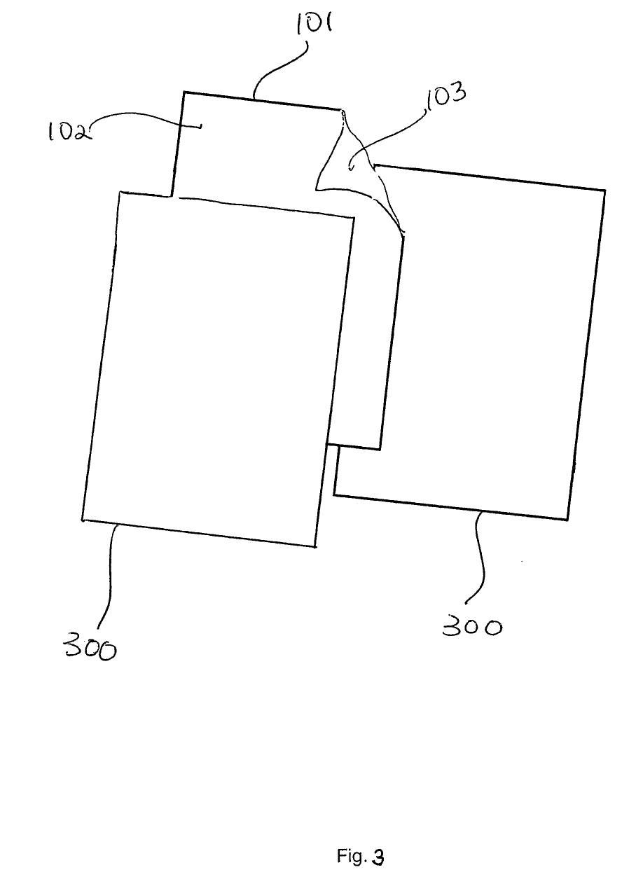

FIG. 4 is front view of a conformable design template having a design pattern comprising printed design elements;

FIG. 5 is front view of a conformable design template having a design pattern comprising embossed design elements;

FIG. 6 is front view of a conformable design template having a design pattern comprising cutout design elements;

FIG. 7 is front view of a conformable design template having a design pattern comprising perforated design elements;

FIG. 8 A is a front view of a substrate to which a conformable design template has been adhered showing a cut out portion of the substrate pumpkin shell corresponding to one of the printed design elements on the conformable sheet.

### DETAILED DESCRIPTION

Conformable design templates and methods for making and using the same are provided for rendering a design on, or through, all or a portion of a substrate, such as, for example, a pumpkin, other large fruit or vegetable, artificial replicas of the same, and other compliant substrates. The conformable design templates are particularly useful for facilitating the etching or carving of pumpkins and similar vegetables and replicas thereof for display as decor, and more particularly as holiday decor items. The conformable design templates include conformable sheets that are reversibly adherent when contacted with a substrate, such as when contacted with the surface of a substrate. As such, the conformable sheets allow for precise rendering of designs on or through a substrate using one or a selection of piercing or cutting tools to simultaneously pierce or cut the conformable sheet and the substrate. In some embodiments, the conformable design templates are adapted for user-directed application of design templates or patterns using conventional printing equipment, or other writing, marking, cutting, etching or engraving tools or implements. The methods include interactive systems for preparing and using the disclosed conformable design templates.

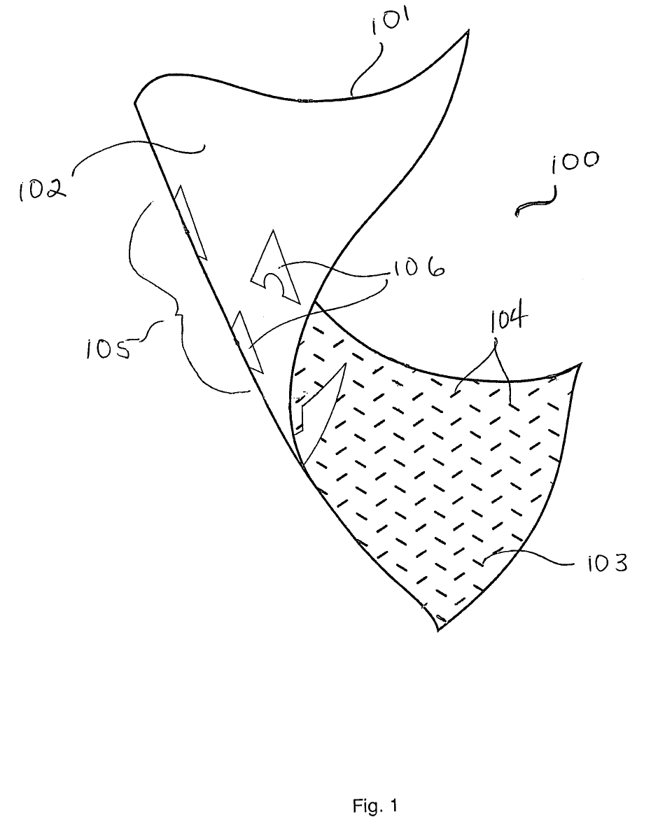

FIG. 1 shows a representative embodiment of a conformable design template according to the present invention. The conformable design template 100 depicted in FIG. 1 comprises a conformable sheet 101 which comprises first and second sides, which as depicted, include a pattern side 102, and an opposed bonding side 103. In the depicted embodiment, the bonding side comprises a bonding material 104 disposed on or impregnated into the surface of the bonding side 103. In some embodiments, as depicted in representative FIG. 1, the pattern side 102 comprises one or more design patterns 105 which include one or more design pattern elements 106. The design pattern 105 is used as a guide in rendering a design on the surface of, or through, all or a portion of a substrate. Of course, it is understood that the illustrated embodiment represents but one possible form of a conformable sheet 101. In other embodiments, the bonding side 103 and may also be the design pattern side such that the design pattern and the bonding surfaces are not opposed (not shown). In yet other embodiments, portions of a design pattern may be on the bonding side 103, while portions of the design pattern may be on the side opposing the bonding side. And in yet other embodiments, the conformable sheet may have design pattern elements 106 rendering through the entire sheet, such that at least a portion of the design is not exclusive to either side of the sheet.

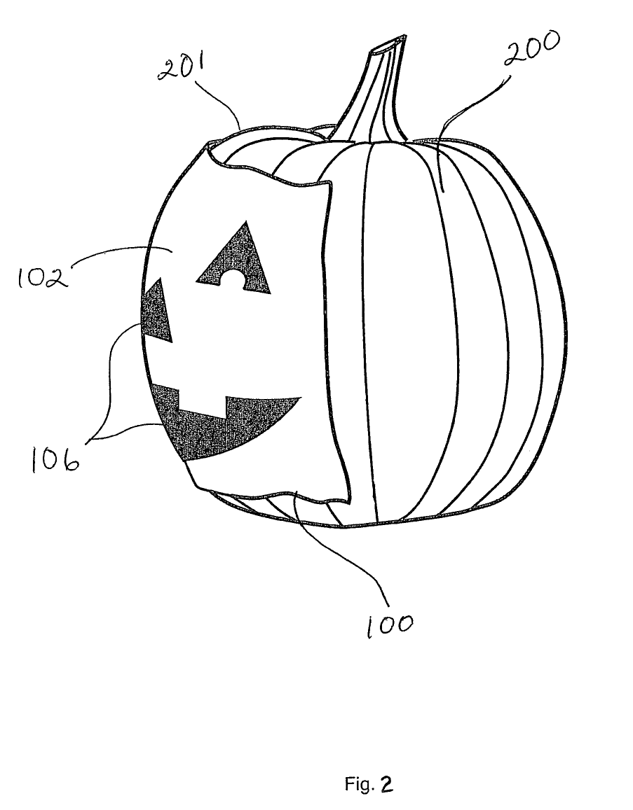

FIG. 2 shows an example of a representative substrate 200, a pumpkin. Of course, substrates may take a variety of forms, including various vegetables, fruits, artificial replicas of the same, or other three dimensional objects which can be altered by carving, etching, engraving or other such alteration. Referring to FIG. 2, a conformable design template 100 is contacted on its bonding side 103 with the substrate 200 on the substrate surface 201, with the design side 102 of the conformable design template 100 facing the user and oriented away from the substrate surface 201.

In various embodiments, the conformable sheet 100 comprises a film. As used herein “film” refers to any thin, flexible, permeable or impermeable material that is may be used for a variety of purposes, such as to wrap or cover items such as foodstuffs for domestic or commercial applications, or to wrap or contain non-food items, e.g., pallets of paper, bulk goods, etc., or to contain or package other items for storage, transportation or display. Films may comprise any thin, flexible material, including, but not limited to, paper, wax, polymeric or plastic films, cloths or fabrics, wovens, nonwovens, laminates, metal foils such as aluminum foil, coated papers, such as wax paper, wax-based paper or grease-proof paper, and combinations thereof. The properties of a film can include, though are not restricted to, combinations or degrees of porosity (porous, non-porous, microporous), permeability (gas or liquid permeable, non-permeable), hydrophilicity, hydrophobicity, hygroscopicity, oleophilicity, oleophobicity, high critical surface tension, low critical surface tension, surface texturing, elasticity, plasticity, transparency or opacity, electrical conductivity (electrically conductive, or electrically non-conductive).

In various embodiments, films are opaque, semi-opaque, transparent or semi-transparent, non-permeable, and semi-elastic. Films may comprise suitable polymeric materials that include, but are not limited to, polyethylene, ethylene copolymers such as ethylene-vinyl acetate (EVA), polypropylene, polyester (PET), polyvinyl chloride (PVC), polyvinylidene chloride and copolymers (PVDC), latex structures, polystyrene, nylon, etc. Films used in accordance with the present invention are tacky but will not be self-adherent to the point as to be difficult to handle or dispense from a rolled, stacked or other stored state. Films used for preparing conformable sheets 101 reversibly adhere to substrate surfaces 201 without marring substrate surfaces 201, and conform to the shape of substrates 200.

Thicknesses of films used according to the present invention to prepare conformable sheets 101 are from about 0.0001 inches (0.0025 mm) to about 0.010 inches (0.25 mm). More preferred thicknesses are from about 0.0002 inches (0.005 mm) to about 0.002 inches (0.051 mm). Even more preferred thicknesses are from about 0.0003 inches (0.0076 mm) to about 0.001 inches (0.025 mm). In one preferred embodiment, the film thickness is 0.0007 inch (0.0178 mm).

In some embodiments, conformable sheets 101 are made from an adhesive or auto-adhesive material. By auto-adhesive, it is meant a material that is inherently capable of adhering to other materials and generally has the properties of an adhesive or bonding material, and does not necessarily comprise applied or embedded adhesive or bonding materials. In other embodiments, conformable sheets 101 comprise a bonding material 104 disposed on, or impregnated into the surface of, the bonding side 104 of the conformable sheets 101. The bonding material 104 is for the purpose of achieving reversible contact and adhesion of the conformable sheets 101 to substrate surfaces 201. As used herein, “bonding material” includes one or more of the types of materials typically considered for use to adhere one material to another material, such as a film to the surface of a substrate. Bonding materials include, but are not limited to, glues, solvent-based adhesives, emulsions, heat-sealable adhesives, hot-melt pressure sensitive adhesives, pressure sensitive adhesives, cohesives, and lacquers. Where the bonding material is a pressure-sensitive adhesive, the materials must first be contacted then pressure applied to achieve bonding between the material surfaces. Where the bonding material is a cohesive, a similar cohesive material must be present or placed on the adjacent surface for engaging with the cohesive material when the two surfaces are contacted. Where the bonding material is heat sealable, the materials must be brought into contact and then heat must be applied to effect the seal. Where the bonding material is a lacquer, heat, sound waves, or vibrations may be applied to effect the sealing of the lacquer. Of course, a wide variety of non permanent bonding materials are well known in the art and selection of such materials can be readily achieved by one of ordinary skill.

A bonding material 104 may be applied to a conformable sheet 101 by any conventional application method known in the art. Known methods of application include roller application, drop, spray, printing, transfer, extrusion, brush, pads, or combinations thereof. A bonding material can be applied to a continuous film or to an individual sheet of film to form conformable sheets 101 of varying lengths. A bonding material 104 may be applied in a continuous or discontinuous fashion, that is to cover all or only portions or a portion of a film surface. In some embodiments, bonding materials may be applied in a pattern, whether regular or irregular. The conformable sheets 101 of the present invention include embodiments in which the bonding material 104 is applied in a continuous layer over the surface of the film, or applied in discrete regions, either large or small (e.g., by spraying, or printing). In some embodiments, the bonding material 104 is applied to the film at a level that is sufficient to achieve reversible contact and adhesion with substrate surfaces 201. In some embodiments, the bonding material 104 is applied in a liquid or semi-liquid, or solid or semi-solid form at a level of from about 0.0001 grams per square meter of film (“gsm”) to about 100 gsm, preferably from about 0.1 to about 50 gsm, more preferably from about 0.5 gsm to about 20 gsm, even more preferably from about 1 to about 10 gsm, and most preferably from about 1 gsm to about 5 gsm. In other embodiments, the bonding material 104 may be applied at levels that are greater or lesser than those recited with respect to liquid forms of bonding material 104, wherein such levels of application are sufficient to achieve reversible contact and attachment of conformable sheets 101 to substrate surfaces 201.

In one embodiment, conformable sheets 101 comprise a flexible, semi-transparent polymeric or wax-based film having a pressure sensitive bonding side 104 and a relatively non adherent design side 102. In another embodiment, conformable sheets 101 comprise a flexible, semi-transparent polymeric or wax-based film having a pressure sensitive bonding side 104 onto which a pattern design 105 is or can be rendered, wherein the patterned bonding side 104 opposes a relatively non adherent side. In yet other embodiments, both sides of the conformable sheets 101 are adherent.

In some embodiments, the conformable sheets 101 of the present invention comprise backing sheets 300 to which the film is reversibly adhered. In certain embodiments, the conformable sheets 101 are adhered to backing sheets 300 by contact between the bonding side 103 of the conformable sheet 101 and the backing sheet 300. In such embodiments, the pattern side 102 of the conformable sheet 101 is exposed. In alternate embodiments, a conformable sheet 101 is adhered to a backing sheet 300 by contact between the pattern side 102 of the conformable sheet 101 and the backing sheet 300, such that the bonding side 103 of the conformable sheet 101 is exposed. In yet other embodiments, the conformable sheet 101 may be reversibly adhered to two backing sheets 300, wherein backing sheets 300 are reversibly adhered on both the bonding side 103 and pattern side 102. In such cases, the bonding side 103 and pattern side 102 backing sheets 300 may be of the same or different materials.

Backing sheets 300 may comprise paper, plastic, cloth or fabric, woven, non-woven, laminate, metal foil such as aluminum foil, coated paper, such as wax paper or grease-proof paper, and combinations thereof. Backing sheets 300 provide support and stability to the conformable sheets 101 for storage or other purposes. In some embodiments, backing sheets 300 are suitable for use in printing devices such as dot matrix, laser, and ink jet printers, copy machines, and the like. According to such embodiments, the conformable sheets 101 may comprise instructions or other information to guide a user with respect to use of the conformable design templates 100, in particular with respect to use according to the interactive methods of the present invention, as described herein, wherein such instructions may be preprinted on either the conformable sheet 101 film or on one or more backing sheets 300.

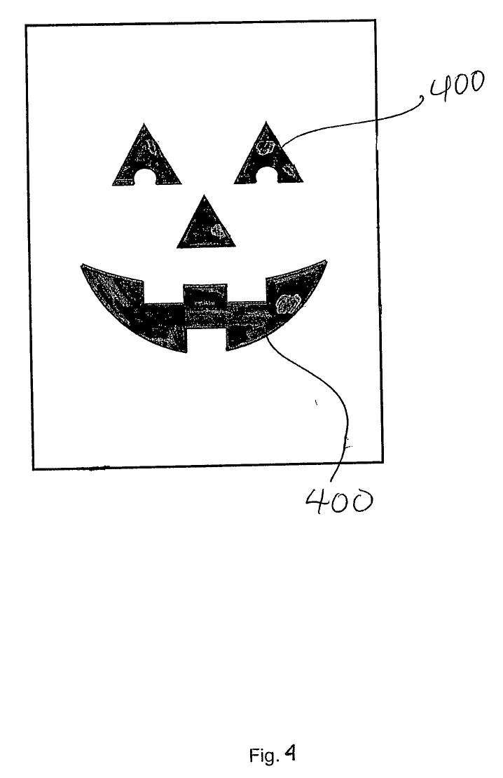

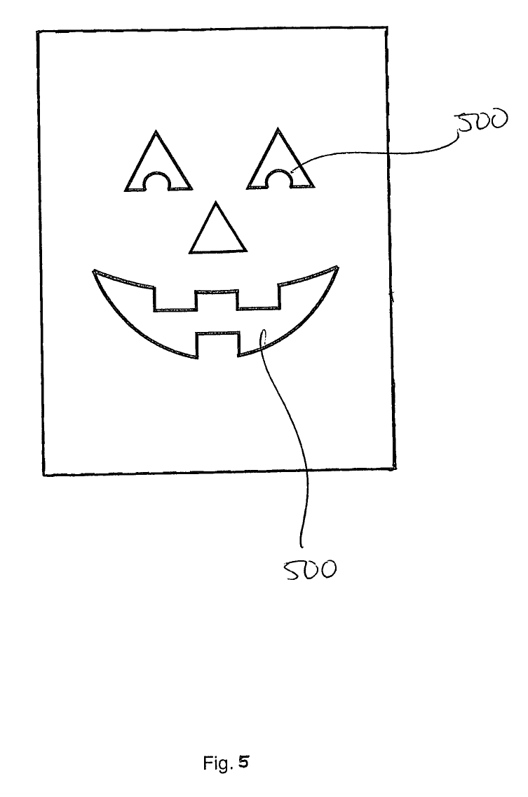

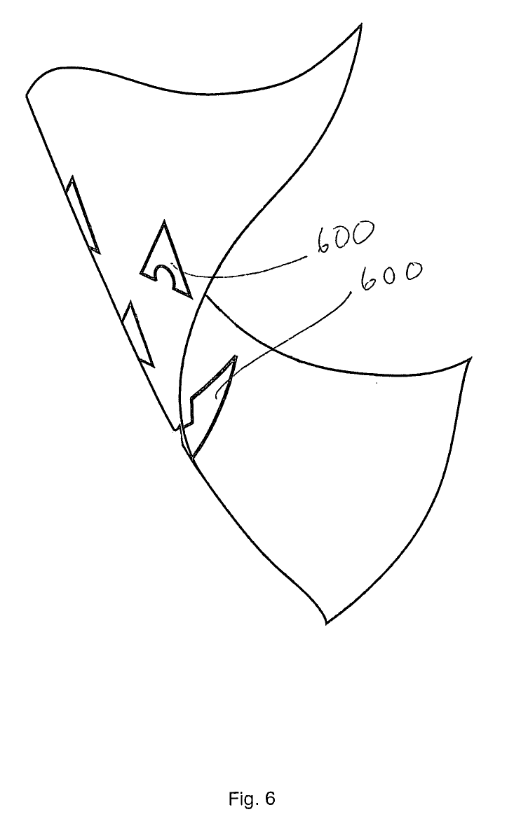

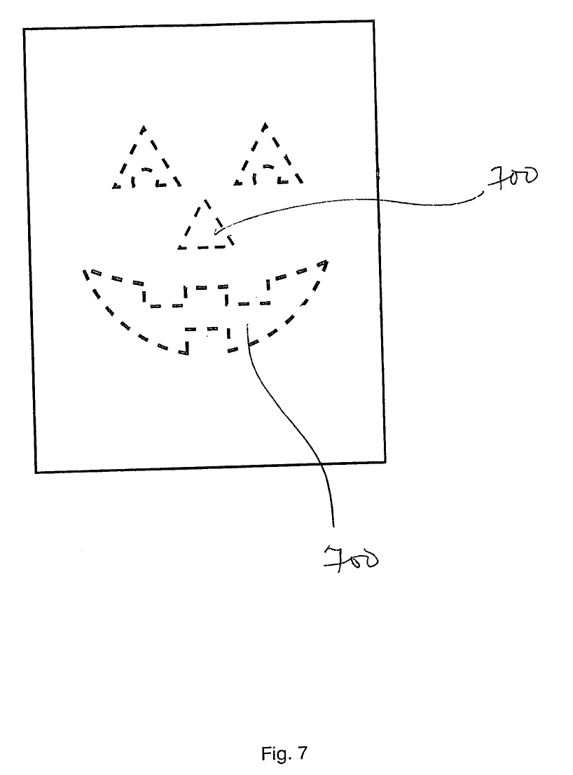

In some embodiments, conformable sheets 101 are adapted to receive patterns 105 that are applied using conventional printers, such as ink jet or laser printers, or are otherwise applied using ink, lead, graphite or other markers, or etching or impression using appropriate tools. Pattern elements 106 may be rendered on the pattern side 105 of conformable design templates 100 by printing, embossing, etching, or in the form of cutouts or perforations, or combinations of thereof. FIG. 4-FIG. 7 depict a variety of different embodiments of design patterns 105, wherein the design patterns 105 are rendered on the conformable sheets 101 in the form of printed pattern elements 400 (FIG. 4), embossed pattern elements 500 (FIG. 5), cutout pattern elements 600 (FIG. 6) and perforated pattern elements 700 (FIG. 7). Of course, other methods of rendering design patterns 105 on materials such as the disclosed conformable sheets 101 are well known in the art, and are encompassed within the scope of the disclosed invention. Conformable sheets 101 are removed from backing sheets prior to application to a substrate.

Conformable design templates 100 are in the form of rolls or sheets of varying lengths. In some embodiments, conformable design templates 100 are in rolls comprising a series of one or more repeated designs, wherein the rolls are wound such that the conformable design templates 100 may be dispensed by the user as needed. In such embodiments, the rolls may be wound such that the pattern side 102 is exposed, or alternatively, such that the bonding side 103 is exposed. The individual conformable design templates 100 in a roll may be pre cut or have perforations to enable easy separation of each conformable design template 100. Alternatively, separation of the conformable design templates 100 may be achieved by use of a cutting tool. In some embodiments, rolls of conformable design templates 100 are provided in packaging which include cutting implements. In other embodiments, conformable design templates 100 are provided as single or multiple sheet packs. In some embodiments, the packs are provided in reams of multiple sheets. Conformable design templates 100 in either roll or sheet form may comprise backing sheets 300. In roll form, the backing sheets 300 are continuous with the roll of conformable design templates 100.

In accordance with the present invention, users of conformable design templates 100 may custom prepare or modify conformable sheets 101 with a variety of user selected designs, which may be user designed, or obtained from a web-site or other source, such as identified on the conformable design template 100 packaging material. Using printers or other writing, marking, cutting, etching or engraving tools or implements that are suitable for the type of film used in the conformable design templates 100, users may create or otherwise render user-selected design images on the conformable sheets 100. Such images may be thematic, such as pertaining to holidays such as Halloween, Christmas, or other holidays. Images may likewise be related to other events such as birthdays, or may relate to well known characters or images in print or other media.

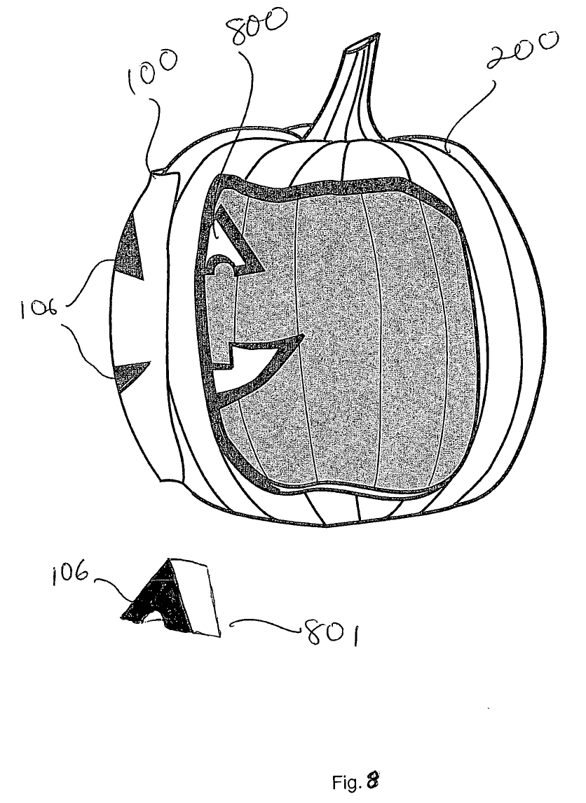

Conformable design templates 100 are used in accordance with the present invention to render designs on substrates 200. Referring to FIG. 8, a conformable design template 100 is attached to a pumpkin substrate 200. The user simply follows the design pattern 105 to alter the substrate by following the design pattern 105 using a tool such as a knife or other specialized carving implement. At the users option, the substrate 200 shell may be pierced through and carved away to yield a cut out substrate portion 801 as represented in the FIG. 8, wherein the cut-out substrate portion 801 corresponds to a pattern element 106. Alternatively, a user may simply follow the design pattern 105 to introduce multiple pierces or perforations into the substrate 200 (not shown). Alternatively, a user may use an appropriate tool to partially pierce or gouge or route the surface of the substrate 200 to produce partial cutouts, grooves, dents, etcetera, without producing any cut-outs (not shown). In some embodiments, the conformable design template 100 may be keyed such that certain of the pattern elements 106 direct the user to produce cut outs of substrate pieces, while other pattern elements 106 direct the user to produce perforations, gouges, routes, etches or other alterations in the substrate 200 (not shown).

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

While particular embodiments of the subject invention have been described, it will be obvious to those skilled in the art that various changes and modifications of the subject invention can be made without departing from the spirit and scope of the invention. In addition, while the present invention has been described in connection with certain specific embodiments thereof, it is to be understood that this is by way of illustration and not by way of limitation and the scope of the invention is defined by the appended claims which should be construed as broadly as the prior art will permit.

What is claimed is:

1. A conformable design template for rendering a pattern on a substrate, comprising:
a flexible conformable sheet having one or more design pattern elements defined thereon or therethrough and adapted to conform to a substrate surface when applied thereto, the sheet comprising one or more layers, and having first and second sides, at least one of which sides is a bonding side that has an adhesive surface.

2. The conformable design template according to claim 1 wherein said bonding side comprises a self adhesive film.

3. The conformable design template according to claim 1 wherein the film is reversibly adhesive when contacted with a substrate surface.

4. The conformable design template according to claim 1 wherein said bonding side comprises a pressure-sensitive adhesive film.

5. The conformable design template according to claim 1 wherein said bonding side comprises a heat-sensitive adhesive film, or a coating of adhesive applied thereto.

6. The conformable design template according to claim 5 wherein the bonding side comprises an adhesive coating that has an adhesive state and a non-adhesive state, and wherein said adhesive coating is in said non-adhesive state until coming in contact with an activating agent.

7. The conformable design template according to claim 1 wherein said conformable sheet is semi-transparent.

8. The conformable design template according to claim 1 wherein the design pattern elements are defined on the bonding side.

9. The conformable design template according to claim 1 wherein the design pattern elements are defined through the conformable sheet.

10. The conformable design template according to claim 1 wherein the design pattern elements are defined on the side opposing the bonding side, and wherein the design pattern element side is non-adhesive.

11. The conformable design template according to claim 1 wherein said conformable sheet comprises an adhesive layer and a non-adhesive layer.

12. The conformable design template according to claim 1 wherein said conformable sheet comprises a polymeric or wax-based film.

13. A conformable design template for rendering a pattern on a substrate, comprising:
a flexible conformable sheet being adapted to receive one or more design patterns to be rendered thereon or therethrough and being adapted to conform to a substrate surface when applied thereto, the sheet comprising one or more layers, and having first and second sides, at least one of which sides is a bonding side that has an adhesive surface.

14. The conformable design template according to claim 13 wherein said bonding side comprises a self adhesive film.

15. The conformable design template according to claim 13 wherein the film is reversibly adhesive when contacted with a substrate surface.

16. The conformable design template according to claim 13 wherein said bonding side comprises a pressure-sensitive adhesive film.

17. The conformable design template according to claim 13 wherein said bonding side comprises a heat-sensitive adhesive film, or a coating of adhesive applied thereto.

18. The conformable design template according to claim 17 wherein the bonding side comprises an adhesive coating that has an adhesive state and a non-adhesive state, and wherein said adhesive coating is in said non-adhesive state until coming in contact with an activating agent.

19. The conformable design template according to claim 13 wherein said conformable sheet is semi-transparent.

20. The conformable design template according to claim 13 wherein the design pattern elements are defined on the bonding side.

21. The conformable design template according to claim 13 wherein the design pattern elements are defined through the conformable sheet.

22. The conformable design template according to claim 13 wherein the design pattern elements are defined on the side opposing the bonding side, and wherein the design pattern element side is non-adhesive.

23. The conformable design template according to claim 13 wherein said conformable sheet comprises an adhesive layer and a non-adhesive layer.

24. The conformable design template according to claim 13 wherein said conformable sheet comprises a polymeric or wax-based film.

25. The conformable design template according to claim 13 wherein said conformable sheet further comprises a backing sheet adapted to allow said sheet to be fed through a design rendering device.

26. A conformable design template for rendering a pattern on a substrate, comprising:
a flexible, semi-transparent conformable sheet adapted to conform to a substrate surface when applied thereto, the sheet comprising one or more layers, at least one of which layers comprises a polymeric or wax-based film, the sheet having first and second sides, at least one of which sides is a bonding side that has an adhesive surface that is reversibly adherent when contacted with a substrate surface, and at least one of which sides comprises one or more design pattern elements defined thereon or therethrough.

27. A conformable design template for rendering a pattern on a substrate, comprising:
a flexible, semi-transparent conformable sheet adapted to conform to a substrate surface when applied thereto, the sheet comprising one or more layers, at least one of which layers comprises a polymeric or wax-based film, the sheet having first and second sides, at least one of which sides is a bonding side that has an adhesive surface that is reversibly adherent when contacted with a substrate surface, and at least one of which sides is a design pattern side adapted to receive one or more design patterns to be rendered thereon or therethrough, and at least one backing sheet adhered to the conformable sheet.
